(19) United States
(12) Patent Application Publication
(10) Pub. No.: US 2011/0098417 A1
(43) Pub. Date: Apr. 28, 2011

(54) POLYURETHANE POLYMER SYSTEMS

(75) Inventors: William G. Worley, Missouri City, TX (US); Harshad M. Shah, Missouri City, TX (US); Phillip S. Athey, Lake Jackson, TX (US); Christian Bruchertseifer, Tecklenburg (DE); Gerhard Mueller, Adlington (GB)

(73) Assignee: Dow Global Technologies Inc., Midland, MI (US)

(21) Appl. No.: 12/673,790

(22) PCT Filed: Sep. 17, 2008
(86) PCT No.: PCT/US08/76614

§ 371 Date: Feb. 17, 2010

Related U.S. Application Data
(60) Provisional application No. 60/974,107, filed on Sep. 21, 2007.

(51) Int. Cl. C08G 18/69; C08G 18/12

(52) U.S. Cl. 525/328.8; 525/380

(57) ABSTRACT

The present invention is to the preparation and application of isocyanate based polymers, particularly polyurethane and polyurea elastomeric polymers. By incorporating polybutadiene with a polyether polyol in a polyurethane system, the produced elastomer have improved chemical resistance as compared to conventional polyurethane elastomers. For polyurea elastomer, the incorporation of high functional polyols or crosslinkers with polybutadiene gives elastomer with improved chemical resistance as compared to conventional polyurea elastomers.

The present invention relates generally to the preparation and application of isocyanate based polymers, particularly polyurethane and polyurea elastomeric polymers. In particular such polymers are prepared where a portion of the composition for the polymer is a polybutadiene.

### BACKGROUND OF THE INVENTION

Elastomers generally stretch under tension, have a high tensile strength and retract rapidly to the original dimension when the applied stress is released. Such elastomers can be used in a variety of applications including open casting techniques, injection molding and spray coating of surfaces.

Spray elastomers are a relatively young class of polyurethane elastomeric materials which have been introduced to the coatings industry about 20 years ago. Over the past decade, these spray applied polyurethane and polyurea polymers have found rapid acceptance in the protective coating industry due to their high reactivity, speed of application and mechanical strength and toughness. Such elastomers are widely used as coating on various substrates, such as metals, plastic, wood and concrete. For example, large containers, pipe housing, etc. are items which are subject to highly abrasive conditions and can be protected by an elastic, wear resistance covering.

Recently contractors and applicators have felt encouraged by their success to venture into harsher applications environments like chemical processing infrastructure, power generation, paper mills or mining.

However, due to the severity of the chemical and/or thermal exposure, spray elastomers have performed only marginally in these applications and have not been proven as a viable alternative to incumbent protection solutions like epoxy, polyester or vinylester coatings.

U.S. Pat. No. 6,797,789 describes a phenolic/polyurea elastomeric coating system reported to have improved chemical resistance. Such a system is based on an isocyanate quasi-prepolymer of an isocyanate and the other reactive component contains an amine-terminated polyether polyols, amine-terminated chain extenders and phenolic resins. U.S. Pat. No. 5,077,349 describes highly flexible polyurethane plastics and coatings which are resistant to chemicals and a process for their production. The reactive systems have a polyisocyanate component which is reacted with a hydroxy terminated polybutadiene polyol, water, alkaline earth metal hydroxides or oxides and organic auxiliaries like bitumen and additives. The polymer is processed with e.g. rollers or spatulas and is particularly suitable for large-area seals on concrete surfaces like e.g. garage decks or bridges.

There continues to be a need to improve the chemical resistance of polyurethane coatings to open up new market segments and satisfy the needs of the protective coatings applicator.

The objective of the present invention is to provide for non-cellular isocyanate based polymers which exhibit good chemical resistance, specifically acid resistance while preserving optimal set rates and flowability. The polymers also have good adhesion properties to allow attachment of the polymers to a substrate to provide a protective coating.

### SUMMARY OF THE INVENTION

Polymers produced from the formulations of the present invention have good chemical resistance making them suitable for a number of coating, lining and molding applications.

The present invention is an elastomer which is the reaction product of

a) an isocyanate component comprising an isocyanate-terminated prepolymer having and isocyanate (NCO) content of 5 to 25 weight percent where the prepolymer is the reaction product of a stoichiometric excess of one or more di- or polyisocyanates with a first polyol composition; and
b) a second polyol composition;
c) optionally in the presence of chain extenders and/or cross linkers, and
d) optionally catalysts and other additives

wherein a), b) and any chain extenders or cross linkers are provided at an isocyanate index of 90 to 115 and from 4 to 60 wt % of the elastomer is derived from a at least one polybutadiene polyol having a functionality of 1.8 to 2.1 and an average molecular weight of 500 to 10,000 and the portion of the first or second polyol which is not polybutadiene is a polyol or polyol blend having a nominal functionality of 1.8 to 2.5 and an average molecular weight of 500 to 10,000,

with the proviso when b) and c) contain amine terminate molecules to give greater than 50% urea linkages formed by reaction of the isocyanate with a), b) or a combination thereof, from 5 to 40 wt % of components b) and c) have an average functional of 4 or greater.

In a second embodiment, the present invention is a process for the preparation of a isocyanate based non-cellular polymers comprising the reaction of

a) an isocyanate component comprising an isocyanate-terminated prepolymer having and isocyanate (NCO) content of 5 to 25 weight percent where the prepolymer is the reaction product of a stoichiometric excess of one or more di- or polyisocyanates with a first polyol composition; and
b) a second polyol composition;
c) optionally in the presence of chain extenders and/or cross linkers, and
d) optionally catalysts and other additives known per se in the production of elastomers

wherein a), b) and any chain extenders or cross linkers are provided at an isocyanate index of 90 to 115 and from 4 to 60 wt % of the elastomer is derived from a at least one polybutadiene polyol having a functionality of 1.8 to 2.1 and an average molecular weight of 500 to 10,000 and the portion of the first or second polyol which is not polybutadiene is a polyol or polyol blend having a nominal functionality of 1.8 to 2.5 and an average molecular weight of 500 to 10,000,

with the proviso when b) and c) contain amine terminate molecules to give greater than 50% urea linkages formed by reaction of the isocyanate with a), b) or a combination thereof, from 5 to 40 wt % of components b) and c) have an average functional of 4 or greater.

In another embodiment, the invention is an article, coating, adhesive, binding or thermoplastic comprising the elastomer as described above.

In a further embodiment, the invention is an article, coating, adhesive, binding or thermoplastic formed using the process described above.

### DETAILED DESCRIPTION OF THE PREFERRED EMBODIMENT

The present invention relates to the preparation and application of plural component coating systems that exhibit improved chemical resistance as compared to conventional polyurethane or polyurea coating systems. The improved properties make such coating systems suitable for use in corrosive environments.

As used herein the term polyols are materials having at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups per molecule are especially preferred due to their desirable reactivity with polyisocyanates.

As used herein the term “convention polyol” or “additional polyol” is used to designate a polyol other than a polybutadiene polyol.

The presence of polybutadiene as part of the polyol component for producing the non-cellular polymers, i.e. elastomers, of the present invention, give polymers with improved properties. It is believed the hydrophobic nature of the hydroxy terminated polybutadiene resin imparts improved chemical resistance to such elastomers against various media like aqueous acids and bases, some solvents and aqueous solutions of various salts. Total immersion tests of the sprayed polymers in various chemicals as mentioned above show reduced swelling and dimensional change as well as maintenance of the structural integrity of the parts as compared to conventional polyurethane or polyurea based elastomers.

When the polyol component b), chain extenders, and/or cross-linkers contain active amine hydrogen groups, the reaction of such active amine hydrogen groups with the isocyanate component of a) results in the formation or urea linkages. Thus polyurea elastomers referred to herein are those formed from reaction mixtures having at least about 50 percent of the active hydrogen groups in the form of amine groups. Preferably, the reaction mixtures have at least about 60 percent and more preferably about 70 percent active amine hydrogen groups in the form of amine groups. In a more preferred embodiment, the reaction mixtures have at least about 90 percent of the active hydrogen groups in the form of amine groups.

When the polyol component b), chain extenders, and/or cross-linkers contain active hydroxyl hydrogen groups, the reaction of such active hydroxyl hydrogen groups with the isocyanate component of a) results in the formation or polyurethane linkages. Thus polyurethane elastomers referred to herein are those formed from reaction mixtures having at least about 70 percent of the active hydrogen groups in the form of hydroxyl groups. Preferably, the reaction mixtures have at least about 75 percent and more preferably about 80 percent active hydrogen groups in the form of hydroxyl groups. In a more preferred embodiment, the reaction mixtures have at least about 89 percent of the active hydrogen groups in the form of hydroxyl groups.

While polybutadienes are known for their chemical resistance and good adhesion characteristics, it was unexpectedly found the inclusion of a polybutadiene in a polyurethane polymer, or a polyurea polymer formed in the presence of a high functional crosslinker, provides for enhanced chemical resistance (non-linear response) as compared to a systems based primarily on polybutadiene or a standard polyether polyol.

The enhanced properties of the final elastomer are obtained by incorporating from 5 to 60 weight percent of a polybutadiene in the elastomer. For polyurethane elastomers, preferably the final elastomer contains at least 10 wt % and more preferably at least 15 wt % of a polybutadiene. In one embodiment for such elastomers, the final elastomer contains at least 20 wt % of polybutadiene. In a further embodiment, the final elastomer contains less than 40 wt % and preferably less than 34 wt % of polybutadiene. In one embodiment, the elastomer contains less than 30 wt % of polybutadiene.

For polyurea elastomers of the present invention, it is preferred the polybutadiene comprises at least 20 wt % of the elastomer. In a further embodiment, the elastomer contains at least 30 and more preferably at least 35 wt % of polybutadiene. In another embodiment the polyurea elastomer contains less than 55 wt % polybutadiene and more preferably less than 50 wt % polybutadiene.

While the polybutadiene can be present in the prepolymer a) or the polyol component b), for polyurethane elastomers, generally at least 60 wt % of the polybutadiene is present in the prepolymer. Preferably at least 70 wt % and more preferably at least 80 wt % of the polybutadiene present in the final polymer is present in the prepolymer. In other embodiments at least 90 wt % of the polybutadiene is present in the prepolymer. If desired, all the polybutadiene component can be provided from the prepolymer. In a similar manner, the polybutadiene amounts specified above for the prepolymer can be present in the second polyol component b).

For polyurea elastomers of the present invention, to achieve the desired levels of polybutadiene in the elastomers, the polybutadiene form a portion of the first polyol and second polyol. The amount of polybutadiene present in the second polyol will be limited to the need to obtain the desired polyurea content. Thus in one embodiment, for polyurea elastomers, the first polyol contains at least an amount of polybutadiene as given for the polyurethane elastomers and the second polyol composition contains polybutadiene to give the desired content of polybutadiene in the final elastomer.

The polybutadiene used in the present invention is a non-branched hydroxyl-terminated polybutadiene which contains an average of 1.8 to 2.0 terminal hydroxyl groups and have a weight average molecular weight of 500 to 10,000, preferably from 700 to 8,000 and more preferably about 1,000 to 5,000. More preferably the polybutadiene has a weight average molecular weight of 1,500 to 4,000. Such non-branched polybutadienes are derived from anionic polymerization and are available commercial, for example, from Sartomer as Krasol™ LBH 2000, 3000 and 5000.

To obtain the necessary chemical resistance achieved by including the hydrocarbon backbone in the prepolymer, the polybutadiene is generally present as at least 10 wt % of the polyol in the prepolymer or polyol b). Preferably it is present at a level of at least 20 and more preferably at 25 wt % of the total polyol. In a further preferred embodiment, the butadiene constitutes at least 35 wt % of the total polyol. In one preferred embodiment the polybutadiene is part of the total polyol in the prepolymer. When the polybutadiene is provided as part of a prepolymer, the polybutadiene may comprise up to 90 wt % of the polyol in the prepolymer and even up to 100 wt % of the first polyol. Preferably the polybutadiene comprises up to 75 and more preferably up to 66 wt % of the total polyol in the prepolymer. In one preferred embodiment for polyurethane elastomers of the invention, the polybutadiene comprises up to 50 wt % of the total polyol in the prepolymer.

In addition to the polybutadiene present, an additional polyol may be present in the prepolymer and/or in the polyol component b). Representative polyols include polyether polyols, polyester polyols, polyhydroxy-terminated acetal resins, and hydroxyl-terminated amines. Examples of these and other suitable isocyanate-reactive materials are described more fully in U.S. Pat. No. 4,394,491. Alternative polyols that may be used include polyalkylene carbonate-based polyols and polyphosphate-based polyols. Preferred are polyether or polyester polyols. More preferred are polyether polyols prepared by adding an alkylene oxide, such as ethylene oxide, propylene oxide, butylene oxide or a combination thereof, to an initiator having from 2 to 8, preferably 2 to 6 and more preferable from 2 to 4 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

A blend of polyols may be used and such a blend will generally have an average functionality of 1.8 to 4 and more preferably from 1.8 to 3, more preferably from 1.8 to 2.5. For the production of polyurethane elastomer, the functionality of the polyol blend is from 1.8 to 2.2. The average functionality of the polyol blend does not include any chain extenders or cross-linkers described more fully herein. The average equivalent weight of the polyol or polyol blend is generally from 500 to 3,000, preferably from 750 to 2,500 and more preferably from 1,000 to 2,200.

Exemplary initiators for polyether polyols include, for example, ethanediol, 1,2- and 1,3-propanediol, diethylene glycol, dipropylene glycol, tripropyleneglycol; polyethyleneglycol, polypropylene glycol; 1,4-butanediol, 1,6-hexanediol, glycerol, pentaerythritol, sorbitol, sucrose, neopentylglycol; 1,2-propylene glycol; trimethylolpropane glycerol; 1,6-hexanediol; 2,5-hexanediol; 1,4-butanediol; 1,4-cyclohexane diol; ethylene glycol; diethylene glycol; triethylene glycol; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol; and combination thereof.

Other initiators for polyether polyols include linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

Illustrative polyester polyols may be prepared from organic dicarboxylic acids having from 2 to 12 carbon atoms, preferably aromatic dicarboxylic acids having from 8 to 12 carbon atoms, and polyhydric alcohols, preferably diols, having from 2 to 12, preferably from 2 to 8 and more preferably 2 to 6 carbon atoms. Examples of dicarboxylic acids are succinic acid, glutaric acid, adipic acid, suberic acid, azelaic acid, sebacic acid, decanedicarboxylic acid, malonic acid, pimelic acid, 2-methyl-1,6-hexanoic acid, dodecanedioic acid, maleic acid and fumaric acid. Preferred aromatic dicarboxylic acids are phthalic acid, isophthalic acid, terephthalic acid and isomers of naphthalene-dicarboxylic acids. Such acids may be used individually or as mixtures. Examples of dihydric and polyhydric alcohols include ethanediol, diethylene glycol, triethylene glycol, 1,2- and 1,3-propanediol, dipropylene glycol, 1,4-butanediol and other butanediols, 1,5-pentanediol and other pentanediols, 1,6-hexanediol, 1,10-decanediol, glycerol, and trimethylolpropane. Illustrative of the polyester polyols are poly(hexanediol adipate), poly(butylene glycol adipate), poly(ethylene glycol adipate), poly(diethylene glycol adipate), poly(hexanediol oxalate), poly(ethylene glycol sebecate), and the like.

While the polyester polyols can be prepared from substantially pure reactants materials, more complex ingredients can be used, such as the side-stream, waste or scrap residues from the manufacture of phtalic acid, terephtalic acid, dimethyl terephtalate, polyethylene terephtalate and the like. Other source is the recycled PET (polyethelene terephtalate). After transesterification or esterification the reaction products can optionally be reacted with an alkylene oxide.

Another class of polyesters which may be used are polylactone polyols. Such polyols are prepared by the reaction of a lactone monomer; illustrative of which is &valerolactone, δ-caprolactone, ε-methyl-ε-caprolactone, ξ-enantholactone, and the like; with an initiator that has active hydrogen-containing groups; illustrative of which is ethylene glycol, diethylene glycol, propanediols, 1,4-butanediol, 1,6-hexanediol, trimethylolpropane, and the like. The production of such polyols is known in the art; see, for example, U.S. Pat. Nos. 3,169,945, 3,248,417, 3,021,309 and 3,021,317. The preferred lactone polyols are the di-, tri-, and tetra-hydroxyl functional ε-caprolactone polyols known as polycaprolactone polyols.

Polyols that are derived from renewable resources such as vegetable oils or animal fats can also be used as additional polyols. Examples of such polyols include castor oil, hydroxymethylated polyesters as described in WO 04/096882 and WO 04/096883, hydroxymethylated polyols as described in U.S. Pat. Nos. 4,423,162; 4,496,487 and 4,543,369 and “blown” vegetable oils as described in US Published Patent Applications 2002/0121328, 2002/0119321 and 2002/0090488.

For the production of polyureas, component b) or c) will contain amine terminated molecules. When part of the second polyol b), such active amine hydrogen containing materials are preferably amine-terminated polyethers. Such amine-terminated polyols have a molecular weight of greater than 1,000 and generally greater than 1,500. The preferred amine-terminated polyethers should be selected from aminated diols or triols, and a blend of aminated diols and/or triols may be used. In particular, primary and secondary amine-terminated polyethers with a molecular weight greater than 1000, even more desirably greater than 1500, a functionality from about 2 to about 6, and an amine equivalent weight of from about 750 to about 4000 are preferred. In one embodiment, such amine-terminated polyethers having a functionality of from about 2 to about 3 are used. These materials may be made by various methods known in the art.

The amine-terminated polyethers may be, for example, polyether resins made from an appropriate initiator to which lower alkylene oxides, such as ethylene oxide, propylene oxide, butylene oxide, or mixtures thereof, are added with the resulting hydroxyl-terminated polyol then being aminated. When two or more oxides are used, they may be present as random mixtures or as blocks of one or the other polyether. In the amination step, it is highly desirable that the terminal hydroxyl groups in the polyol be essentially all secondary hydroxyl groups for ease of amination. The polyols so prepared are then reductively aminated by known techniques, for example, such as described in U.S. Pat. No. 3,654,370, the contents of which are incorporated herein by reference. Normally, the amination step does not completely replace all of the hydroxyl groups. However, the greatest majority of hydroxyl groups are replaced by amine groups. Therefore, the amine-terminated polyether resins generally have greater than about 90 percent of their active hydrogens in the form of amine hydrogens.

Examples of such amine terminated polyethers are JEFFAMINE® brand series of polyether amines available from Huntsman Corporation. They include JEFFAMINE® D-2000, JEFFAMINE® D-4000, JEFFAMINE® T-3000 and JEFFAMINE® T-5000. Other similar polyether amines are commercially available from BASF and Arch Chemicals.

The isocyanate-terminated prepolymer for use in the present inventions are prepared by standard procedures well known to a person skilled in the art and such as disclosed in U.S. Pat. Nos. 4,294,951; 4,555,562; 4,182,825 or PCT Publication WO2004074343. The components are typically mixed together and heated to promote reaction of the polyols and the polyisocyanate. The reaction temperature will commonly be within the range of about 30° C. to about 150° C.; a more preferred range being from about 60° C. to about 100° C. The reaction is advantageously performed in a moisture-free atmosphere. An inert gas such as nitrogen, argon or the like can be used to blanket the reaction mixture. If desired, an inert solvent can be used during preparation of the prepolymer, although none is needed. A catalyst to promote the formation of urethane bonds may also be used.

The isocyanate is used in stoichiometric excess and reacted with the polyol component using conventional prepolymer reaction techniques to prepare prepolymers having from 5 to 25 weight percent free NCO groups. The prepolymers generally have from 8 to 20 weight percent free NCO groups, preferably from 10 to 18 weight percent, and more preferably from 14 to 17 weight percent.

When the prepolymer contains polybutadiene and an additional polyol, separate prepolymers may be produced, one based on the isocyanate and polybutadiene and the second based on isocyanate and the additional polyol. The resulting prepolymers can then be blended together to give the desired percent of polybutadiene in the prepolymer. Alternatively, the prepolymer may be prepared by reacting the polybutadiene and additional polyol with the isocyanate simultaneously in a one-pot procedure.

Suitable polyisocyanates for producing the prepolymers include aromatic, cycloaliphatic and aliphatic isocyanates. Such isocyanates are well known in the art.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyante (TDI) m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodi phenylether.

A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. In one embodiment, TDI/MDI blends are used.

Examples of aliphatic polyisocyanates include ethylene diisocyanate, 1,6-hexamethylene diisocyanate, 1,3- and/or 1,4-bis(isocyanatomethyl)cyclohexane (including cis- or trans-isomers of either), isophorone diisocyanate (IPDI), tetramethylene-1,4-diisocyanate, methylene bis(cyclohexaneisocyanate) (H₁₂MDI), cyclohexane 1,4-diisocyanate, 4,4′-dicyclohexylmethane diisocyanate, saturated analogues of the above mentioned aromatic isocyanates and mixtures thereof.

Derivatives of any of the foregoing polyisocyanate groups that contain biuret, urea, carbodiimide, allophonate and/or isocyanurate groups can also be used. These derivatives often have increased isocyanate functionalities and are desirably used when a more highly crosslinked product is desired.

Preferably the polyisocyanate is diphenylmethane-4,4′-diisocyanate, diphenylmethane-2,4′-diisocyanate, polymers or derivatives thereof or a mixture thereof. In one preferred embodiment, the isocyanate-terminated prepolymers are prepared with 4,4′-MDI, or other MDI blends containing a substantial portion or the 4,4′-isomer or MDI modified as described above. Preferably the MDI contains 45 to 95 percent by weight of the 4,4′-isomer.

It is also possible to use one or more chain extenders for the production of polyurethane polymers and elastomers of the present invention. The presence of a chain extending agent provides for desirable physical properties, of the resulting polymer. The chain extenders may be blended with the polyol component ii) or may be present as a separate stream during the formation of the polyurethane polymer. For purposes of this invention, a chain extender is a material having two isocyanate-reactive groups per molecule and an equivalent weight per isocyanate-reactive group of less than 400, preferably less than 300 and especially from 31-125 daltons. Representative of suitable chain-extending agents include polyhydric alcohols, aliphatic diamines including polyoxyalkylenediamines, aromatic diamines and mixtures thereof. The isocyanate reactive groups are preferably hydroxyl, primary aliphatic or aromatic amine or secondary aliphatic or aromatic amine groups. Representative chain extenders include ethylene glycol, diethylene glycol, 1,3-propane diol, 1,3- or 1,4-butanediol, dipropylene glycol, 1,2- and 2,3-butylene glycol, 1,6-hexanediol, neopentylglycol, tripropylene glycol, ethylene diamine, 1,4-butylenediamine, 1,6-hexamethylenediamine, phenylene diamine, 1,5-pentanediol, 1,6-hexanediol, bis(3-chloro-4-aminophenyl)methane, 3,3′-dichloro-4,4-diaminodiphenylmethane, 4,4′-diaminodiphenylmethane, bisphenol-A; bisphenol-F, 1,3-propane di-p-aminobenzene, methylene bisorthochloroaniline (MOCA), 1,3-cyclohexandiol, 1,4-cyclohexanediol; 2,4-diamino-3,5-diethyl toluene 1,3-cyclohexane dimethanol, 1,4-cyclohexane dimethanol, and mixtures thereof. If used, chain extenders are typically present in an amount from about 0.5 to about 20, especially about 2 to about 16 parts by weight per 100 parts by weight of the polyol component. Such chain extenders are generally added in the production of elastomer.

As an amine chain extender would introduce polyurea into the final elastomer, which gives a faster curing/reaction time, for the present invention where a polyurethane elastomer is preferred, the amount of amine chain extender would be limited such that the ratio of polyurethane to polyurea bonds is as given above. Chain extenders are generally added to the second polyol component, however; if desired, the chain extenders added to the isocyanate terminated prepolymer to partially react out the free isocyanate groups.

Crosslinkers may also be included in formulations for the production of polyurethane polymers of the present invention. For purposes of this invention “crosslinkers” are materials having three or more isocyanate-reactive groups per molecule and an equivalent weight per isocyanate-reactive group of less than 400. Crosslinkers preferably contain from 3-8, especially from 3-4 hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, sorbitol, diethyltoluenediamine (DETA), meta-dianiline, and other diamine cross-linkers known to those skilled in the art.

For producing a polyurethane based elastomer, amounts of crosslinkers generally used are from about 0.1 to about 1 part by weight, especially from about 0.25 to about 0.5 parts by weight, per 100 parts by weight of polyols.

When producing polyurea elastomers, the urea content may come from reaction of the isocyanate with amine terminated polyols present in the second polyol b) or provided by the presence of amine terminated chain extenders or amine terminated prepolymers. In one embodiment, all the active amine hydrogen atoms are provided from amine terminated chain extenders and/or crosslinkers. In one preferred embodiment, all the active amine hydrogen atoms are provided from amine terminated crosslinkers.

Furthermore, when producing polyurea elastomers, components b) and c) will contain from 5 to 50 wt % of molecules having a nominal functionality of 4 or more; referred to in this paragraph as higher functional molecules. Generally the functionality of such molecules will not be greater than 8 and preferably no greater than 6. Preferable the amount of these higher functional molecules is present from 8 to 42 and more preferably from 15 to 38 wt % of components b) and c). In one embodiment, reactive components having a functionality of 4 or greater are provided by polyols in the second polyol b) and from crosslinkers of c). In a further embodiment, polyols of b) having a functionality of 4 or more are hydroxyl terminated polyether polyol and the crosslinkers of c) are amine terminated crosslinkers. In still another embodiment; the amount of higher functional polyols in b) will be from 1 to 8 and more preferably from 2.5 to 5.5 wt percent of the total weight of b) and c). In another embodiment, the amount of higher functional crosslinkers will be from 10 to 35 and more preferably from 15 to 32 wt % of components b) and c).

The ratio of equivalents of isocyanate groups in the polyisocyanate a) to the active hydrogens in polyol component b) plus those present for any added chain extenders or crosslinkers is generally from 85 to 115. Preferably the isocyanate index is at a ratio of 90 to 110 and more preferably from 95 to 110. The isocyanate index is known to those skilled in the art and is the mole equivalents of isocyanate (NCO) divided by the total mole equivalents of isocyanate-reactive hydrogen atoms present in a formulation, multiplied by 100.

To obtain adequate curing rates, a catalyst may be included within the polyol component. Suitable catalysts include the tertiary amine and organometallic compounds such as described in U.S. Pat. No. 4,495,081. When using an amine catalyst advantageously it is present in from 0.1 to 3, preferably from 0.1 to 1 and more preferably from 0.4 to 0.8 weight percent by total weight of polyol and optional chain extending agent. When the catalyst is an organometallic catalyst, advantageously it is present in from 0.001 to 0.2, preferably from 0.002 to 0.1 and more preferably from 0.01 to 0.05 weight percent by total weight of polyol and optional chain extending agent. Particularly useful catalysts include in the case of amine catalysts; triethylenediamine, bis(N,N-dimethylaminoethyl)ether and di(N,N-dimethylaminoethyl)amine and in the case of the organometallic catalysts; stannous octoate, dibutyltin dilaurate, and dibutyltin diacetate. Combinations of amine and organometallic catalysts advantageously may be employed.

The viscosity of the prepolymers may be reduced by the mixing with diluents known to those skilled in the art. One preferred diluent is propylene carbonate.

Various other additives generally known to those skilled in the art can be added to the elastomers. For example, pigments, such as titanium dioxide and/or carbon black, may be incorporated in the elastomer system to impart color properties. Pigments may be in the form of solids or the solids may be pre-dispersed in a resin carrier. Reinforcements, for example, flake or milled glass, and fumed silica, may also be incorporated in the elastomer system to impart certain properties. Other additives such as UV stabilizers, antioxidants, air release agents, adhesion promoters, or structural reinforcing agents may be added to the mixture depending on the desired characteristics of the end product. These are generally known to those skilled in the art. The amount of any such additive is not taken into consideration when determining the weight percent of polybutadiene in the final polymer.

The elastomers of the present invention are applicable for use in applications which require heavy duty anticorrosion properties like floors in chemical or food processing plants, pickup-bed linings, reservoirs linings, storage tanks, floors etc. Alternatively the polymers can be used for applications requiring higher thermal resistance or applications requiring high hydrolysis resistance like marine coatings.

The polyurethane polymer prepared according to the process of this invention is a solid or a microcellular polyurethane polymer. Such a polymer is typically prepared by intimately mixing the reaction components at room temperature or a slightly elevated temperature for a short period and then pouring the resulting mixture into an open mold, or injecting the resulting mixture into closed mold, which in either case is heated. The mixture on reacting out takes the shape of the mold to produce a polyurethane polymer of a predefined structure, which can then when sufficiently cured be removed from the mold with a minimum risk of incurring deformation greater than that permitted for its intended end application. Suitable conditions for promoting the curing of the polymer include a mold temperature of typically from 20° C. to 150° C., preferably from 35° C. to 75° C., and more preferably from 45° C. to 55° C. Such temperatures generally permit the sufficiently cured polymer to be removed from the mold typically in from 1 to 10 minutes and more typically from 1 to 5 minutes after intimately mixing the reactants. Optimum cure conditions will depend on the particular components including catalysts and quantities used in preparing the polymer and also the size and shape of the article manufactured.

For elastomeric spray coatings, the components are generally applied via processing through plural high pressure spray machines. The plural component equipment combines the two components a) and b) while the b) component generally includes other additives as described above. The isocyanate a) and polyol b) are preferably combined or mixed under high pressure. In a preferred embodiment, they are impingement mixed directly in the high-pressure spray equipment. This equipment for example includes: GUSMER H-2000, GUSMER H-3500, GUSMER H-20/35 and Glas-Craft MH type proportioning units fitted with either a GUSMER GX-7, GUSMER GX-7 400 series or GUSMER GX-8 impingement mix spray gun. The two components are mixed under high pressure inside the spray gun thus forming the coating/lining system, which is then applied to the desired substrate via the spray gun. The use of plural component spray equipment, however, is not critical to the present invention and is included only as one example of a suitable method for mixing the isocyanate and polyol components of the present invention.

It should be understood that the present description is for illustrative purposes only and should not be construed to limit the scope of the present invention in any way. Thus, those skilled in art will appreciate that various modifications and alterations to the presently disclosed embodiments might be made without departing from the intended spirit and scope of the present invention. Additional advantages and details of the present invention are evident upon an examination of the following examples and appended claims.

A description of the raw materials used in the examples is as follows.
Antifoam 1500 is a silicone surfactant.
BYK-088 is obtained from BYK-Chemie and is described as a silicone and polymer defoamer.
Dabco 33LV is a tertiary amine catalyst commercially available from Air Products & Chemicals Inc. under the trade designation Dabco 33 LV.
DBTDL is dibutyl tin dilaurate.
DETA is diethyltoluenediamine.
PBD is a polybutadiene polyol having an average functionality of 1.9 (diol) and an average MW of 2000 obtained from Sartomer under the trade name of Kraysol LBH-2000.
VORASTAR* HB 6042 is a prepolymer based on methylene diisocyanate and a blend of 1000 and 2000 MW propylene oxide diols having a free isocyanate content of about 15 wt %; available from The Dow Chemical Company.
ISONATE* 50-OP is monomer MDI; 50/50 2,4′/4,4′ ratio of about 50/50 available from The Dow Chemical Company.
VORANOL* 220-110N is an all propylene oxide diol with an average MW of 1000, obtained from The Dow Chemical Company.
ISONATE 143L is a polycarbodiimide-modified diphenylmethane diisocyanate, with an equivalent weight of about 144.5 available from The Dow Chemical Company.
L-Paste is 50/50 mix of molecular sieve and castor, used as a dehydrating agent.
VORANOL 4701 is a glycerine initiated polyoxypropylene polyether polyol with a 13 to 14 wt % ethylene oxide cap, and an average equivalent weight of about 1650, available from The Dow Chemical Company.
VORANOL V220-056N is a propylene glycol initiated, propylene oxide polyol with an average molecular weight of 2000, available from The Dow Chemical Company.
TONE* Polyol 32B8, is a 1,6-hexanediol initiated polycaprolactone polyester having an average molecular weight of approximately 400.
Voranol RA 800 is 4 functional amine initiated polyol, with a reported hydroxyl number of 780-820, average MW 280, and viscosity @25° C. of 17000 mPa s available from The Dow Chemical Company.
VORANOL RH 360 is an approximately a 4.7 functional polyether polyol, with a hydroxyl number of 345-375 and an average MW of 700 available from The Dow Chemical Company.
VORANATE HB 6042 is an NCO terminated prepolymer based on Isonate 50 OP; Voranol 220-056N and Voranol 220-110N having an NCO content of 15.6 wt %.
VORASTAR* HA 6153 is described as a blend having from 50-70 wt polypropylene glycol bis(aminopropyl)ether; 25-40 wt % diethylmethylbenzene diamine (DETA); and 5-15 wt % of polyoxypropylene triamime; available from The Dow Chemical Company.

### *VORASTAR, VORANATE, VORANOL, TONE, and ISONATE are all Trademarks of The Dow Chemical Company.

### Example 1

Prepolymer 1: To a glass jar is added 53 parts by weight (pbw) of Isonate 50-OP followed by the addition of 39 pbw of PBD and 1 drop of benzoyl chloride while purging with nitrogen. The mixture is stirred for 5 minute at 500 rpm under nitrogen purging and then placed in a preset oven at 70′C for 3 hours. The resulting Prepolymer 1 has an NCO-value of about 16.0% NCO by weight. Prior to combining with the polyol component b), ten parts by weight of propylene carbonate is added to reduce the viscosity.
Prepolymer 2 (Comparative): Following the procedure for producing Prepolymer 1, a prepolymer is synthesized by reacting 34.6 pbw of Voranol 220-110N with 65.4 pbw Isonate 143L. The resulting prepolymer has an average NCO-value of about 15.9% NCO by weight.
Prepolymer 3. Following the procedure for producing Prepolymer 1, a prepolymer is synthesized by mixing materials in the following amounts, based on parts by weight: 56.21 Isonate OP 50; 46.83 PBD; 0.02 benzoylchloride. The final prepolymer has a free isocyanate content of about 16 wt
Polyol Component for polyurethane plaques

The standard polyol blend for mixing with the prepolymer for producing polyurethane plaques consists of 50 pbw Voranol 4701; 20 pbw Voranol V220-056N; 10 pbw TONE Polyol 32B8; 10 pbw Voranol 800; 5 pbw 1,4-butanediol, and 0.8 pbw BYK-088.

### Plaque Formation

Plaques are made using a mixture of 100 pbw of the standard polyol mixture above with 103 pbw of the prepolymer blend (NCO Index=1.07). This mixture is stirred for about 5 minutes and poured into a mold and placed in a heated press for 1 hour at 70° C. Next, plaques are placed in an oven for 23 hours at 70° C. to ensure a complete cure.

Plaques are tested for Tensile Strength and percent elongation at break using ASTM D1708 and Tear Strength using ASTM D624 C-Tear. Shore A Hardness is measured using ASTM D2240.
The physical properties of the produced plaques are given in Table 1.

TABLE 1
Physical Properties of Plaques

| | | Tensile | | Tear | |
|---|---|---|---|---|---|
| | | Strength | % Elongation | Strength | Shore A |
| Example | Prepolymers | (psi) | at Break | (pli) | Hardness |
| C1* | 100% Prepolymer 1 | 1435 | 185 | 110 | 81 |
| 1 | 75 wt % Prepolymer 1 | 1696 | 182 | 144 | 87 |
| | 25 wt % Prepolymer 2 | | | | |
| 2 | 50 wt % Prepolymer 1 | 1987 | 183 | 174 | 87 |
| | 50 wt % Prepolymer 2 | | | | |
| 3 | 25 wt % Prepolymer 1 | 1903 | 173 | 157 | 88 |
| | 755 wt % Prepolymer 2 | | | | |
| C2* | 100% Prepolymer 2 | 1748 | 175 | 148 | 84 |
| | (comparative 2) | | | | |

*C1 and C2 are comparative examples

As can be seen in Table 1, plaques of Cl have lower tensile strength and tear strength than those of C2. One would expect the plaques from blends of the two prepolymers would result in properties between plaques derived from the two pure prepolymers. Surprisingly the physical properties of two of the blends (Examples 1-3) exceed the tensile and tear strength of both pure materials. Also the percent elongation at break is not sacrificed for the improvements in tensile and tear strength.

Examples 4 and 5. Polyurea elastomers are prepared by blending Prepolymer 3 with the resin composition given in Table 2 at a volume mixing ratio of 100:100 giving isocyanate index of about 110. Comparative 3 (C3) is prepared by blending at a 100:100 volume ratio Vorastar HA 6153 and Vorastar 6042.

TABLE 2

| | Example 4 | Example 5 |
|---|---|---|
| PBD | 65.00 | 65.00 |
| Voranol RA 800 | 6.70 | 4.65 |
| Voranol RH 360 | 5.50 | 1.50 |
| DETDA | 16.00 | 19.00 |
| L-Paste | 2.00 | 1.90 |
| C12-C14 Alkylglcidylether (AGE) | | 7.00 |
| 1,6 Hexanediol Diglycidylether | 4.00 | |
| Antifoam 1500 | 0.50 | 0.50 |
| Dabco 33 LV | 0.20 | 0.30 |
| DBTDL | 0.10 | 0.15 |
| Total | 100 | 100.00 |
| Hydroxyl Number | 234 | 208 |
| Viscosity (23 deg C.) [mPas] | 7050 | 3490 |

The mechanical properties of control plaques (Comparative 3) and plaques produced in Example 4 are given in Table 3.

TABLE 3
Mechanical property of plaques.

| Mechanical Properties | C3 | Example 4 |
|---|---|---|
| Elongation at break [%] | 410 | 150 |
| Tensile strength [N/mm2] | 15.0 | 11.1 |
| Tear strength [N/mm] | 55.0 | 10.1 |
| Shore hardness A/D | 88/45 | 80 |
| Abrasion [mm3] | 288 | 247 |

The stability of the formed plaques of examples C3, 4 and 5 to various solvent is given in Table 4.

TABLE 4

| | | | Polyol Based System | |
|---|---|---|---|---|
| | Control (C3) | | of Examples 4 or 5 | |
| | % weight | | % weight | |
| Medium | gain | Remarks | gain | Remarks |
| HCl 37% | | | 23.80 | Example 5 |
| | | | 4.50 | Example 4 |
| H2SO4 30% | 0.83 | yellowing on surface | 1.43 | Example 4 |
| H2SO4 96% | | | | discs remain, surface |
| | | | | destroyed |
| HNO3 40% | 18.94 | dark red surface | 1.66 | Example 4; surface |
| | | swollen/destroyed | | col. turns to brownish |
| CH3COOH 100% (Glacial | 427.67 | strong swelling, | 31.10 | Example 4 |
| acetic acid)) | | cracks, deformation | | |
| Citric acid 1% | 1.87 | | 0.28 | Example 4 |
| H2O2 30% | 12.63 | yellowing on surface | 1.16 | Example 5 |
| NaOH 60% | −0.72 | | 0.03 | Example 4 |
| NH3 28% | 1.30 | | 1.01 | Example 4 |
| Sodium carbonate | 0.86 | | 0.13 | Example 4 |
| solution (20%) | | | | |
| Soap solution (1%) | 2.00 | | 1.09 | Example 4 |
| Demineralized water | 1.86 | | 0.37 | Example 4 |
| NaCl solution/Salt | 0.54 | | 0.16 | Example 4 |
| brine (27-30%) | | | | |
| N,N Dimethylformamide | | fragments, destroyed | 122.70 | Example 5 |
| | | | 82.23 | Example 4 |
| Ethyl acetate | 137.89 | | 106.03 | Example 5 |
| Acetone | 98.00 | | 51.53 | Example 4 |
| Methytethylketone (264 h !!!) | 141.9 | | 100.8 | Example 4 |
| Toluene | 145.89 | | 135.55 | Example 4 |
| Mineral Oil | 0.16 | | 2.81 | Example 4 |
| Benzene | 167.6 | cracks, deformation | 137.40 | Example 4 |
| Ethanol | 94.79 | deformation, cracks | 5.44 | Example 4 |
| Methanol | 75.49 | | 7.39 | Example 4 |
| Tetrahydrofurane | 321.3 | cracks, deformation | 232.50 | Example 4 |
| Diesel fuel | 3.90 | | 28.32 | Example 4 |
| Detergent solution | | | 0.70 | Example 4 |

The results show the polybutdiene based systems trend overall to have improved stability to various solvents versus the control.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. An elastomer which is the reaction product of
a) an isocyanate component comprising an isocyanate-terminated prepolymer having and isocyanate (NCO) content of 5 to 25 weight percent where the prepolymer is the reaction product of a stoichiometric excess of one or more di- or polyisocyanates with a first polyol composition; and
b) a second polyol composition;
c) optionally in the presence of chain extenders and/or cross linkers, and
d) optionally catalysts and other additives known per se in the production of elastomers,
wherein a), b) and any chain extenders or cross linkers are provided at an isocyanate index of 90 to 115 and from 4 to 60 wt % of the elastomer is derived from a at least one polybutadiene polyol having a functionality of 1.8 to 2.1 and an average molecular weight of 500 to 10,000 and the portion of the first or second polyol which is not polybutadiene is a polyol or polyol blend having a nominal functionality of 1.8 to 2.5 and an average molecular weight of 500 to 10,000,
with the proviso when b) and c) contain amine terminate molecules to give greater than 50% urea linkages formed by reaction of the isocyanate with a), b) or a combination thereof, from 5 to 40 wt % of components b) and c) have an average functional of 4 or greater.

2. The elastomer of claim 1 wherein the prepolymer has an isocyanate content of 8 to 20 weight percent.

3. The elastomer of claim 2 wherein the prepolymer has an isocyanate content of 10 to 18 weight percent.

4. The elastomer of claim 1 wherein the polybutadiene has an average molecular weight of 700 to 8,000.

5. The elastomer of claim 4 wherein the elastomer is a polyurethane based elastomer and polybutadiene comprises from 10 to 40 weight percent of the final elastomer.

6. The elastomer of claim 5 wherein polybutadiene comprises from 15 to 34 weight percent of the elastomer.

7. The elastomer of claim 4 wherein the elastomer is a polyurea based elastomer and polybutadiene comprises from 20 to 55 weight percent of the elastomer.

8. The elastomer of claim 7 wherein polybutadiene comprises from 30 to 50 weight percent of the elastomer.

9. The elastomer of any one of the preceding claims wherein polybutadiene comprises at least 66 weight percent of the first polyol.

10. The elastomer of claim 9 wherein polybutadiene comprises at least 90 weight percent of the first polyol.

11. A process for the preparation of a isocyanate based non-cellular polymers comprising the reaction of
a) an isocyanate component comprising an isocyanate-terminated prepolymer having and isocyanate (NCO) content of 5 to 25 weight percent where the prepolymer is the reaction product of a stoichiometric excess of one or more di- or polyisocyanates with a first polyol composition; and
b) a second polyol composition;
c) optionally in the presence of chain extenders and/or cross linkers, and
d) optionally catalysts and other additives
wherein a), b) and any chain extenders or cross linkers are provided at an isocyanate index of from 90 to 115 and from 4 to 60 wt % of the elastomer is derived from a at least one polybutadiene polyol having a functionality of 1.8 to 2.1 and an average molecular weight of 500 to 10,000 and the portion of the first or second polyol which is not polybutadiene is a polyol or polyol blend having a nominal functionality of 1.8 to 2.5 and an average molecular weight of 500 to 10,000,
with the proviso when b) and c) contain amine terminate molecules to give greater than 50% urea linkages formed by reaction of the isocyanate with a), b) or a combination thereof, from 5 to 40 wt % of components b) and c) have an average functional of 4 or greater.
